(19) United States
(12) Patent Application Publication
(10) Pub. No.: US 2018/0061455 A1
(43) Pub. Date: Mar. 1, 2018

(54) COMPUTER DEVICE, METHOD, AND GRAPHICAL USER INTERFACE FOR AUTOMATING THE DIGITAL TRANSFORMATION, ENHANCEMENT, AND EDITING OF VIDEOS

(71) Applicant: Matthew Benjamin Singer, New York, NY (US)

(72) Inventor: Matthew Benjamin Singer, New York, NY (US)

(21) Appl. No.: 15/248,898

(22) Filed: Aug. 26, 2016

(51) Int. Cl. G11B 27/036; H04N 9/802; G11B 27/34; H04N 5/76

(52) U.S. Cl. CPC G11B 27/036; H04N 9/802; G06F 3/0482; H04N 5/76; G11B 27/34

(57) ABSTRACT

A computer-implemented method is described for automatically digitally transforming and editing video files to produce a finished video presentation. The method includes the steps of recording or receiving from a user a master video, receiving from the user a selection of video clips, and automatically assembling the master video and video clips into the finished video presentation. In addition audio and visual effects may be added to the finished video presentation. Computer apparatus for performing these steps is also described.

### FIELD OF THE INVENTION

This invention relates to the digital transformation, enhancement, and editing of videos. Specifically, this invention relates to the automatic compilation of a final video presentation incorporating video clips upon completing a recording or selection of a master video.

### BACKGROUND OF THE INVENTION

Millions of video cameras and computer and photo devices that record video are sold worldwide each year in both the professional and consumer markets. In the professional video production sphere, billions of dollars and significant time and resources are spent editing video—taking raw footage shot with these cameras and devices, loading it into manual video editing software platforms, reviewing the footage to find the most compelling portions, and assembling the compelling portions in a fashion that communicates or illustrates the requisite message or story in a focused, engaging way, while adding professional footage transitions, soundtrack layers, and effects to enhance the resultant video.

With all the time, money, and expertise necessary to edit video to a professional level or compelling presentation level, the video editing process can be a daunting task for the average consumer. Even for the video editing professional, high quality video production workflow can take 30 times the resultant video time. For example, a finished two-minute video typically takes 75 minutes to edit using traditional manual video editing software. Beyond the significant time investment, the video editing software technical skill necessary and the advanced shot sequencing, enhancing, and combining expertise are skills that the average consumer does not have and that the professional producer acquires at great cost.

For these reasons, the average consumer typically does not have the resources to transform the raw footage he or she films into professional grade video presentations, often instead settling for overly long collections of un-edited video clips that are dull to watch due to their rambling, aimless nature in aggregate. In the alternative, the consumer might hire a professional video editor for events such as weddings, birthdays, family sports events, etc. and spend significant funds to do so.

Corporations and other organizations also spend significant time and resources to create videos used, for example, to market the company or its products, or to recruit for employment opportunities. The videos may include, for example, footage of employees engaged in work at the company, interview of employees describing their experience at the company, or products the company offers for sale. There is a need for methods and apparatus that are easy to use, configure, and/or adapt to facilitate, transform, and automate the process of creating, enhancing, and editing videos. Such methods and apparatus would increase the effectiveness, efficiency and user satisfaction by producing polished, enhanced video content, thereby opening up the proven, powerful communication and documentation power of professionally edited video to a much wider group of business and personal applications.

### SUMMARY OF THE INVENTION

The above deficiencies and other problems associated with video production are reduced or eliminated by the disclosed multifunction device and methods. In some embodiments, the device is a camera or mobile device inclusive of a camera with a graphical user interface (GUI), one or more processors, memory, and one or more modules, programs or sets of computer instructions stored in the memory for performing multiple functions either locally or remotely via a network. In some embodiments, the user interacts with the GUI primarily through a local computer and/or camera connected to the device via a network or data transfer interface. Computer instructions may be stored in a computer readable storage medium or other computer program product configured for execution by one or more processors.

In one embodiment, the computer instructions include instructions that, when executed by a user, digitally transform and automatically edit video files into finished video presentations based on the following: (a) storing in memory a video clip; (b) recording a master video comprising an audio track and a video track; (c) upon recording the master video, without further input from the user, compiling a video presentation by replacing part of the video track of the master video with the master video clip; and (d) saving the video presentation.

In some embodiments, additional efficiencies may also be achieved by extracting from the video file any still images that may be needed for the video presentation, or adding in and enhancing still images into the finished edited video. Such image or images may be extracted automatically from specified portions of the finished video presentation or they may be extracted manually using a process in which the user employs an interface to view and select the optimal video frame(s), or with the still images supplied by the user and/or created with the camera device or another camera device(s).

In some embodiments, the finished video presentation can be automatically uploaded to a different device, server, web site, or alternate location for public or private viewing or archiving.

The above embodiments can be used in numerous types of sales, event, documentary or presentation video applications by individuals or businesses, including corporate recruiting and marketing videos, wedding videos, travel videos, birthday videos, baby videos, apartment videos, product sales videos, graduation videos, surf/skate/action videos, recital, play or concert videos, sports videos, pet videos.

### BRIEF DESCRIPTION OF THE DRAWINGS

These and other objects, features and advantages will be more readily apparent from the following Detailed Description in which:

FIG. 1 is a schematic diagram of an illustrative computing device used in the practice of the invention.

FIG. 2 is a flowchart depicting several steps in an illustrative embodiment of the method of the invention.

FIGS. 3A-3C are schematic diagrams depicting the application of an illustrative embodiment of an automatic video editing algorithm to a master video and video clips in an illustrative embodiment of the invention.

FIGS. 4A-4I depict the video screen of a hand-held display such as that of a cell-phone during execution of certain of the steps of FIG. 2.

### DETAILED DESCRIPTION

Reference is made in detail to embodiments, examples of which are illustrated in the accompanying drawings. In the following schematic, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

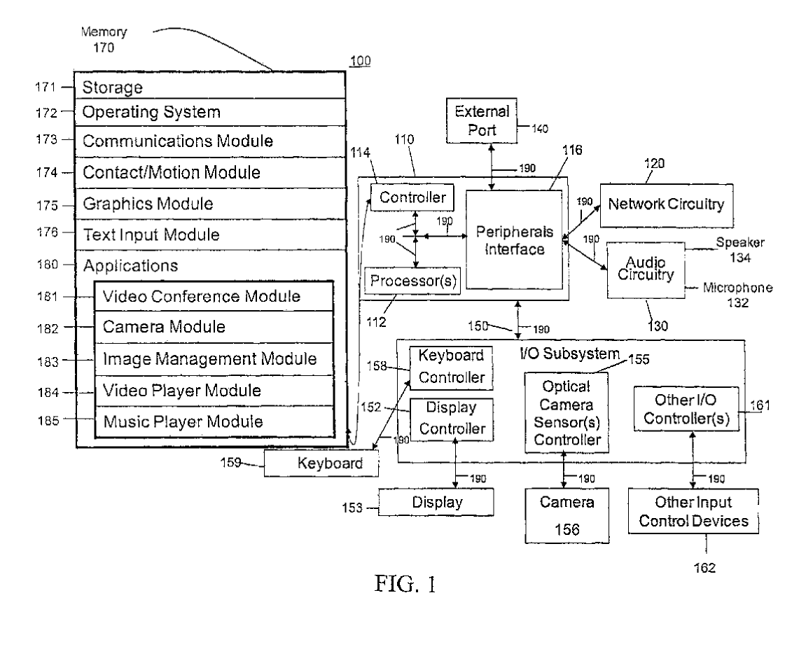

FIG. 1 is a schematic diagram of a computing device 100 that may be used in the practice of the invention. Device 100 comprises a processing unit 110, network interface circuitry 120, audio circuitry 130, external port 140, an I/O video clip system 150 and a memory 170. Processing unit comprises one or more processors 112, a memory controller 114, and a peripherals interface 116, connected by a bus 190. I/O subsystem includes a display controller 152 and a display 153, one or more camera controllers 155 and associated camera(s) 156, a keyboard controller 158 and keyboard 159, and one or more other I/O controllers 161 and associated I/O devices 162. Memory 170 provides general purpose storage 171 for device 100 as well as storage for software for operating the device such as an operating system 172, a communication module 173, a contact/motion module 174, a graphics module 175, a text input module 176, and various application programs 180. The applications programs may include a video conference module 182, a camera module 183, an image management module 184, a video player module 185 and a music player module 186.

The network interface circuitry 120 communicates with communications networks via electromagnetic signals. Network circuitry 120 may include well-known communication circuitry including but not limited to an antenna system, a network transceiver, one or more amplifiers, a tuner, one or more oscillators, a digital signal processor, a CODEC chipset, a subscriber identity module (SIM) card, memory, and so forth. Network circuitry 120 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11 g and/or IEEE 802.11n), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

The audio circuitry 130, including a microphone 132 and a speaker 134, provides an audio interface between a user and the device 100. The audio circuitry 130 receives digital audio data from the peripherals interface 116, converts the digital audio data to an analog electrical signal, and transmits the electrical signal to the speaker 134. The speaker 134 converts the analog electrical signal to human-audible sound waves. The audio circuitry 130 also receives analog electrical signals converted by the microphone 132 from sound waves and converts the analog electrical signal to digital audio data that is transmitted to the peripherals interface 116 for processing. Digital audio data may be retrieved from and/or transmitted to memory 170 and/or the network interface circuitry 120 by the peripherals interface 116. In some embodiments, the audio circuitry 130 also includes a USB audio jack. The USB audio jack provides an interface between the audio circuitry 130 and removable audio input/output peripherals, such as output-only headphones or a microphone.

The I/O subsystem 150 couples input/output peripherals on the device 100, such as display 153, camera 156, keyboard 159 and other input/output devices 162, to the peripherals interface 116. Advantageously, display 153, camera 156, microphone 132, and speaker 134 may all be part of a cell-phone such as an iPhone or similar smartphone. Display 153 may be a touch screen device. As is known in the art, a touch screen display is able to sense when and where its display screen is touched or tapped and correlate the touching with what is displayed at that time and location to derive an input. The I/O subsystem 150 may include a display controller 152, a camera controller 155, a keyboard controller 158, and one or more other input/output controllers 161 for other input or output devices. The one or more other I/O controllers 161 receive/send electrical signals from/to other input/output devices 162. The other input/control devices 162 may include physical buttons (e.g., push buttons, rocker buttons, etc.), dials, slider switches, joysticks, click wheels, track balls, and so forth. In some alternate embodiments, I/O controller(s) 161 may be coupled to any (or none) of the following: an infrared port, USB port, and a pointer device such as a mouse. The one or more buttons may include an up/down button for volume control of the speaker 134 and/or the microphone 132.

The device 100 may also include one or more video cameras 156. Illustratively, the video camera may include charge-coupled device (CCD) or complementary metal-oxide semiconductor (CMOS) phototransistors. The video camera may receive light from the environment, projected through one or more lens, and convert the light to data representing an image. In conjunction with an imaging module, the video camera may be embedded within the computing device, and in some embodiments, the video camera can be mounted in a separate camera housing for both video conferencing and still and/or video image acquisition.

Memory 170 may include high-speed random access memory and may also include non-volatile memory, such as one or more magnetic disk storage devices, flash memory devices, or other non-volatile solid-state memory devices. Memory 170 may be implemented in one or more physical units. Access to memory 170 by other components of the device 100, such as the processor(s) 112 and the peripherals interface 116, may be controlled by the memory controller 114.

The operating system 172 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 173 facilitates communication with other devices over one or more external ports 140 and also includes various software components for handling data received by or transmitted from the network interface circuitry 120.

The graphics module 175 includes various known software components for rendering and displaying the GUI, including components for changing the intensity of graphics that are displayed. As used herein, the term “graphics” includes any object that can be displayed to a user, including without limitation text, icons (such as user-interface objects including soft keys), digital images, videos, animations and the like.

In conjunction with keyboard 159, display controller 152, camera(s) 156, camera controller 155, microphone 132, and graphics module 175, the camera module 183 may be used to capture still images or video (including a video stream) and store them in memory 170, modify characteristics of a still image or video, or delete a still image or video from memory 170. Embodiments of user interfaces and associated processes using camera(s) 156 are described further below.

In conjunction with keyboard 159, display controller 152, display 153, graphics module 175, audio circuitry 130, and speaker 134, the video player module 185 may be used to display, present or otherwise play back videos (on an external, connected display via external port 140 or an internal display). Embodiments of user interfaces and associated processes using video player module 185 are described further below.

It should be appreciated that the device 100 is only one example of a multifunction device, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

In some embodiments, the peripherals interface 116, the CPU 112, and the memory controller 114 may be implemented on a single integrated circuit chip. In some other embodiments, they may be implemented on separate chips.

As set forth above, software for controlling the operation of device 100 is stored in memory 170. In accordance with the invention, the software includes instructions that when executed by processor(s) 112 cause device 100 to edit video files stored in memory 170 to produce a finished video presentation.

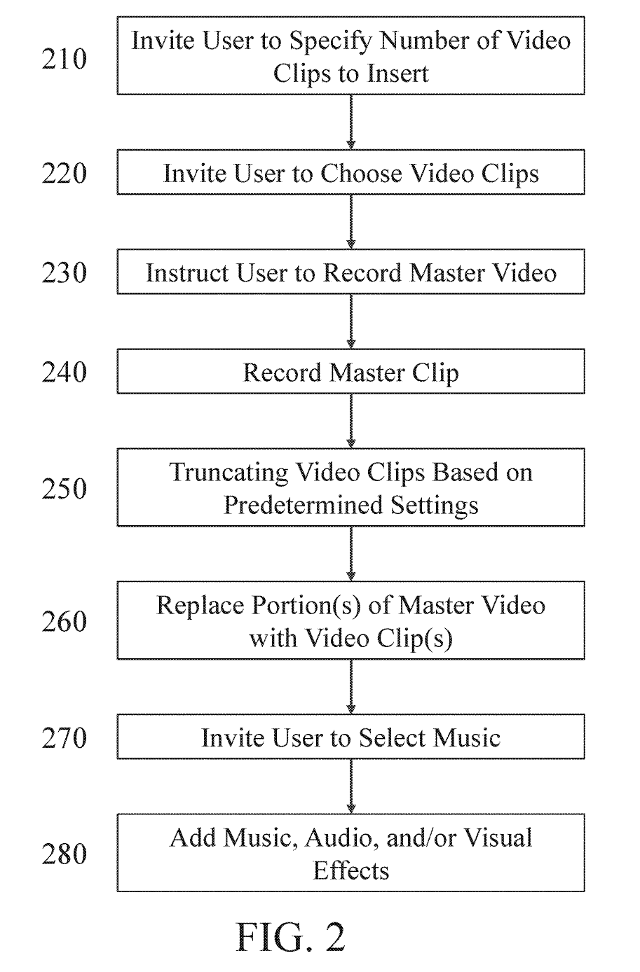

FIG. 2 is a flowchart depicting the steps performed by the software of device 100 in an illustrative embodiment of the invention. The software may be preconfigured or configured by the user as to how many video clips will be in the finished video presentation that is produced in a particular editing assignment. Thus, in some embodiments of the invention, the user is offered no choice in the number of video clips; and the software utilizes a preconfigured number of video clips, for example, one, in each video editing assignment. In other embodiments, when the software is activated, the user is invited at step 210 to specify how many video clips he would like in the finished video presentation. Illustratively, device 100 presents on display 153 a message asking the user how many video clips he would like to use. The user may respond by entering a number via keyboard 159 or by selecting a number on the display. Alternatively, the user may be queried by a voice message using speaker 134, and the user may respond with a spoken number.

In an alternative embodiment, rather than request a number of video clips from the user, device 100 may ask the user to specify what type of video presentation is to be produced. The software may then determine from a look-up table the number of video clips to be used with that type of presentation. In some embodiments, the user may be given the option to alter the number determined from the look-up table. Where the user is asked to specify the type of video presentation, device 100 may present on display 153 a list of types of video presentations and requests the user to select one of the types.

At step 220, the software generates an invitation to the user to choose one or more video clips to be included in the finished video presentation. Typically, the invitation is displayed to the user on display 153 or spoken to the user by speaker 134. In response, the user informs device 100 of his or her choices of the video clips. Advantageously, device 100 presents on display 153 thumb-nail images (either single images, moving videos, or text or symbols) representing each of the available video clips and invites the user to choose the video clips that are desired for incorporation into the finished video. If display 153 is a touch screen, the user can make his or her choices simply by touching or tapping the associated thumb-nail images. In this case, display 153 senses where it has been touched and the computer correlates that information with the display of the thumb-nails to determine which video clip was chosen. The user may also use appropriate scrolling and selection buttons on devices such as a mouse or a track-ball to scroll to the thumb-nail images and choose the desired thumb-nail. Alternatively, the user may choose the video clips by issuing appropriate voice commands that are received by microphone 132.

The order in which the video clips are chosen may determine the order of the video clips in the finished video presentation. Alternatively, the order of the video clips in the finished video presentation may be determined by an organizational structure in which the video clip is stored in memory, or by another file indication assigned to the video clip. For example, the video clips may be ordered in the finished video presentation according to the alphabetic order of a file name assigned to each video clip. Alternatively, the video clips may be ordered in the finished video presentation according to folders in which the video clips are saved in memory.

At step 230, the software generates an instruction to the user to record the master video. Again, device 100 can present this instruction visually by display 153 or audibly by speaker 134.

At step 240, the user records a master video. The master video, including a video track and an audio track, is recorded using camera 156 and microphone 132 operating under software instructions running on one of the processors. At the same time that the master video is recorded, the device 100 may display thumb-nail images of the video clips so that the user may observe the video clips to be included in the final video presentation. For example, consider a situation where the user chooses two video clips, A and B, using one of the procedures described above. Then the user proceeds to record a thirty-second master video. While the user is recording the master video, the software displays thumb-nail images or video representations of video clips A and B on display 153.

The display 153 may indicate the moment each video clip will begin in the final presentation. For example, when the user starts recording the master video, the display 153 may show the video as it is being recorded. A first digital colored frame may be depicted adjacent to the border of the display 153 to indicate that the final presentation will depict the master video during the time that the frame is displayed. The first frame may be black, white, or any color. At the time that a video clip is to be depicted in the final presentation, the first frame may be removed and a second frame may be displayed around the thumb-nail image of the video clip. The second frame may also be black, white, or any color, including a different color than the first frame. Each frame may fade, be erased linearly or otherwise may be gradually removed to indicate that time until the video track of the next video clip or the video track of the master video is to be displayed in the final presentation.

The device 100 may also display during recording of the master video, starting at the time that the video track of a video clip would be inserted, a countdown timer indicating the time remaining before the end of the video clip. In the alternative, while recoding the master video and after the time in the video when the video track of the video clip will be inserted, the device 100 may indicate when the video clip would end.

Immediately after the master video is recorded, device 100 automatically truncates the video clips at step 250 using a pre-specified algorithm that is implemented in software. In one embodiment, the video clips are truncated to a predetermined duration according to the type of video presentation selected by the user.

At step 260 device 100 automatically replaces one or more portions of the video track of the master video with the video track(s)—or the truncated video tracks if truncating is performed at step 250—of the video clips. For example, in one embodiment, the user selects a video presentation type in which one video clip is inserted. In this context, “inserted” means replacing a portion of the video track of the master video with the video track of the video clip. The software may create a video presentation that comprises a first portion of the video track of the master video, followed by the video track of the video clip, followed by an end portion of the video track of the master video.

The software may determine where to insert the video track of the video clip based on a pre-set time. For example, the software may replace a portion of the video track of the master video with the video track of the video clip starting after the first five seconds of the master video. The software may also determine where to insert the video track of the video clip based on a combination of a pre-set time and evaluation of the audio track of the master video. For example, the software may replace a portion of the video track of the master video with the video track of the video clip starting after the first five seconds of the master video, but if there is a break in the speech recorded for the audio track within a predetermined time (e.g., within one or two second) of the point in the master video that is five seconds after the start of the master video, the software may replace a portion of the video track of the master video with the video track of the video clip starting at that break in the speech.

In the example embodiments described above, the audio track of the final presentation may comprise solely the audio track of the master video. In the alternative, at step 270, the software generates an invitation to the user to select music to add as an additional audio track or to replace the audio track of the master video. At step 280 audio effects such as the selected music track and visual effects such as fades and dissolves may be automatically added by the software to the master video and truncated video clips to produce the finished video presentation.

In other embodiments, the user can specify the length of the finished video presentation; the software can automatically add a pre-selected graphic to the beginning and/or ending of the finished video presentation; or the software can use a pre-loaded table to determine the length of the presentation depending on the type of presentation. If a graphic is added at the beginning and/or end of the final video presentation, the software may set the volume of the music to a certain first level when the graphic is displayed, and set the volume of the music to a second level while the video track of the master video and the video clip(s) are displayed. For example, the volume of the music at the second level may be lower than the volume at the first level. The software may also overlay any of the videos with text. For example, the software may display the name of the user at the bottom of the master video. The software may prompt the user to enter their name prior to recording the master video. In the alternative, the user may enter their name or any other text at any time prior to recording the master video. In another alternative embodiment, the user may be required to enter login information (e.g. a login name and password) before using the software. The software may then determine the name of the user based on the login information presented, and display the name of the user or other information relating to the user (e.g., the user's email address, phone number, corporate title) in the master video.

In some embodiments, the user records only an audio track, so only video clip visuals are displayed in the final video composition. In another embodiment, instead of recording a master video or an audio track, the user may select a pre-recorded master video or a prerecorded audio track to be used by the software to create the video presentation.

Furthermore, in some embodiments, one or more of the video clips can be animated photos, where the user selects a photo as the video clip source, and the photo is then transformed into a video clip by the device by reusing pixels from the photo in successive frames with a visual transformation (such as zooming in on the photo), and the length of the animated photo video clip generated by the device is determined by the length between successive taps.

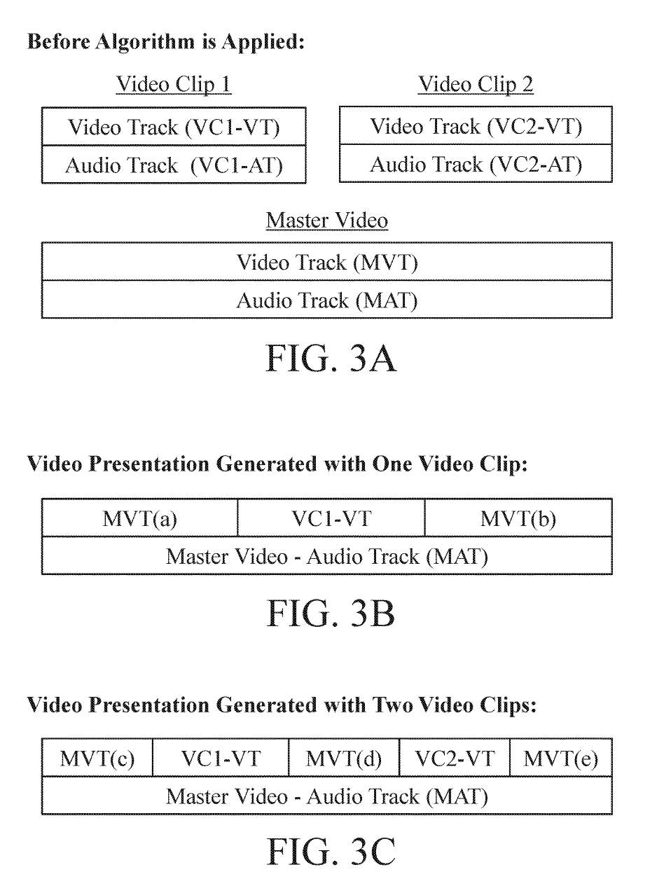

FIGS. 3A-3C are schematic diagrams illustrating the video editing algorithm of FIG. 2. FIG. 3A depicts Video Clip 1 and Video Clip 2, each having an audio track (VC1-AT and VC2-AT, respectively) and a video track (VC1-VT and VC2-VT, respectively). The master video is also depicted as having an audio track (MAT) and a video track (MVT).

FIG. 3B depicts a final presentation compiled by the software when one video clip is inserted. The first portion of the video track of the master video (MVT(a)) and the last portion of the video track of the master video (MVT(b)) are retained. The middle portion of the video track of the master video is replaced with the video track of Video Clip 1 (VC1-VT). The audio track of the master video may be used for the duration of the final presentation.

FIG. 3C depicts a final presentation compiled by the software when two video clips are inserted. The first portion of the video track of the master video (MVT(c)), a middle portion of the video track of the master video (MVT(d)), and the last portion of the video track of the master video (MVT(e)) are retained. Two portions of the video track of the master video are replaced with the video track of Video Clip 1 (VC1-VT) and the video track of Video Clip 2 (VC2-VT), respectively. The audio track of the master video is used for the duration of the final presentation. In the alternative, the video track of Video Clip 2 may be inserted immediately after the video track of Video Clip 1. In that embodiment, only a first portion and a last portion of the video track of the master video would be maintained. The final presentation would depict a first portion of the master video, the video track of Video Clip 1, the video track of Video Clip 2, and the last portion of the master video. The audio track of the master video may be used for the duration of the final presentation.

In summary, by combining the user selected video clips, device directed master clip, and the automatic editing algorithms, the finished video presentation can be automatically assembled without further user input in a machine based transformation much faster than with traditional manual video editing software.

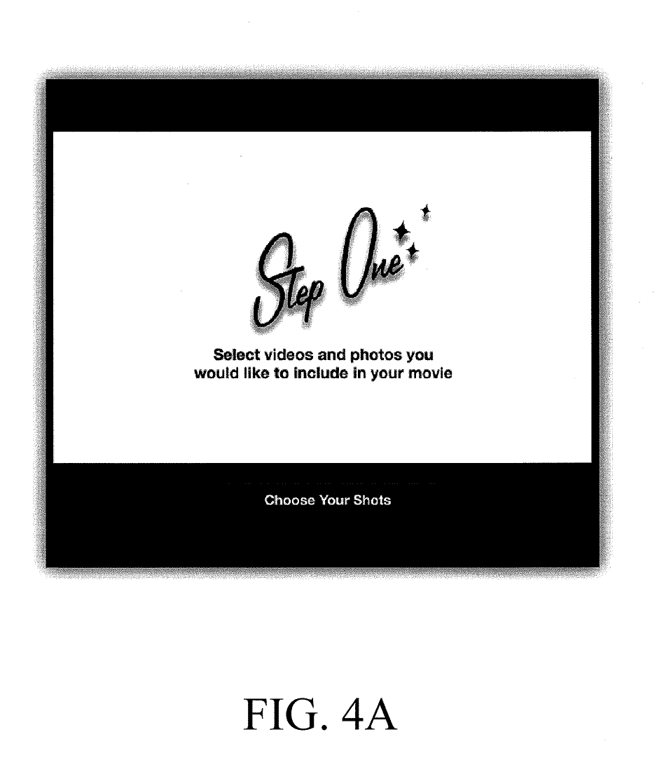

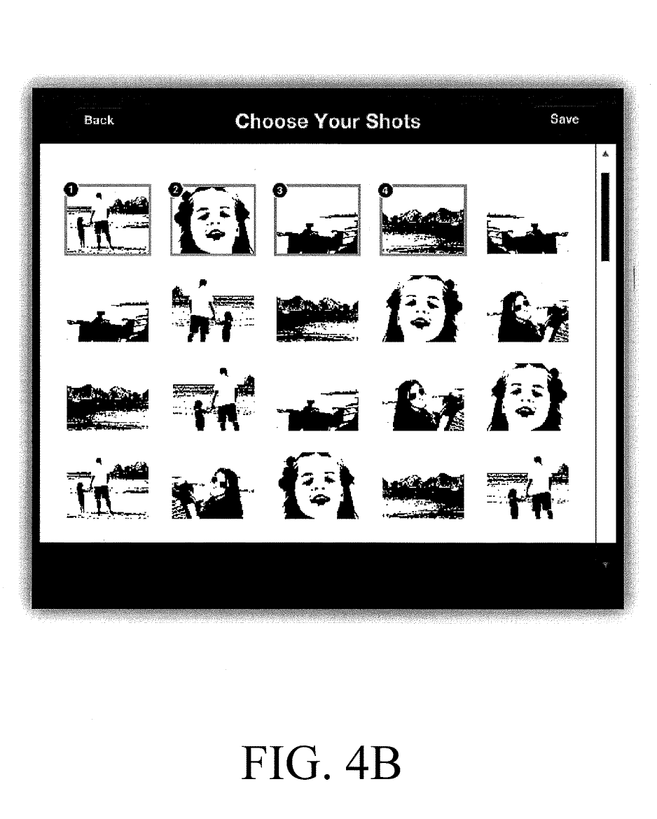

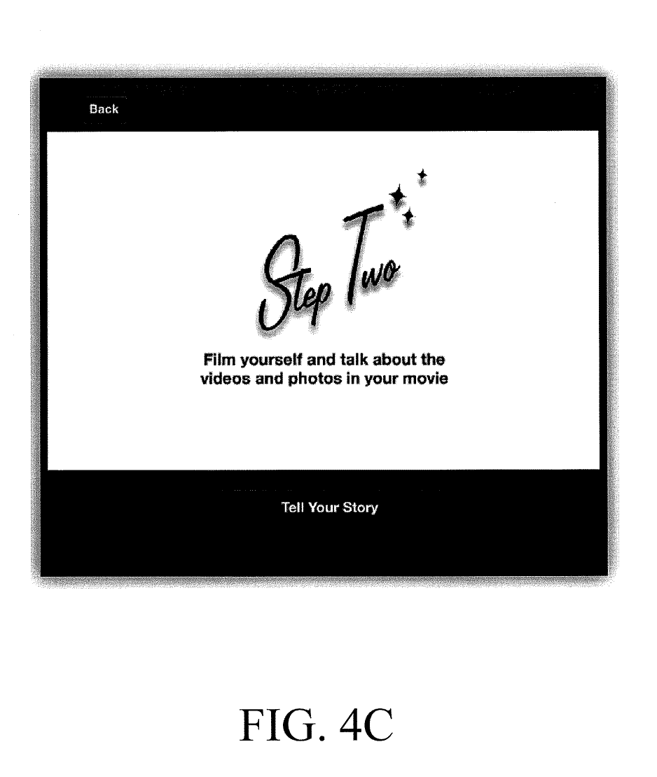

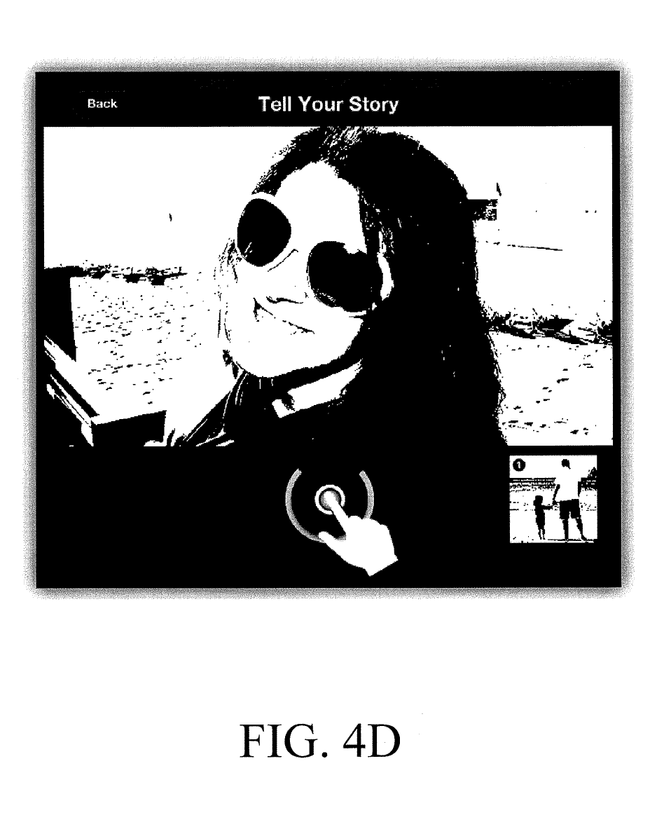

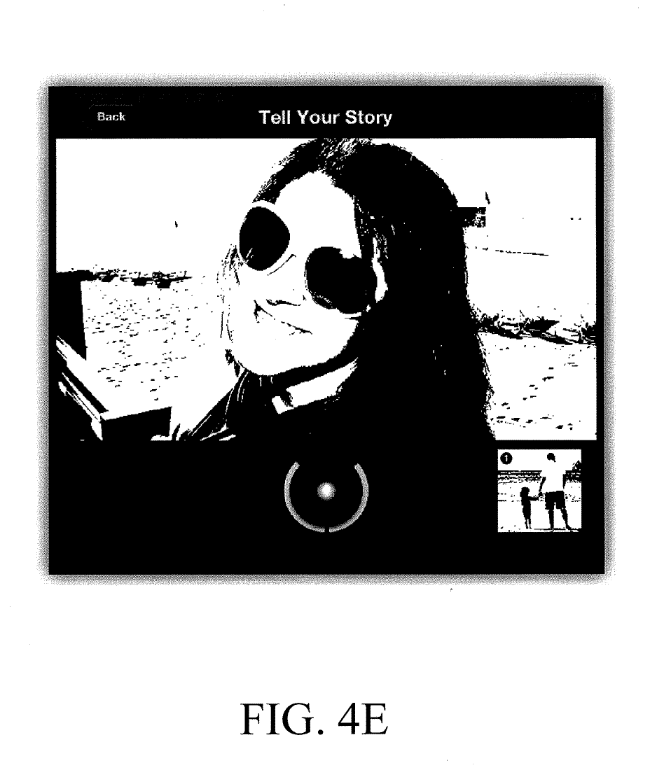

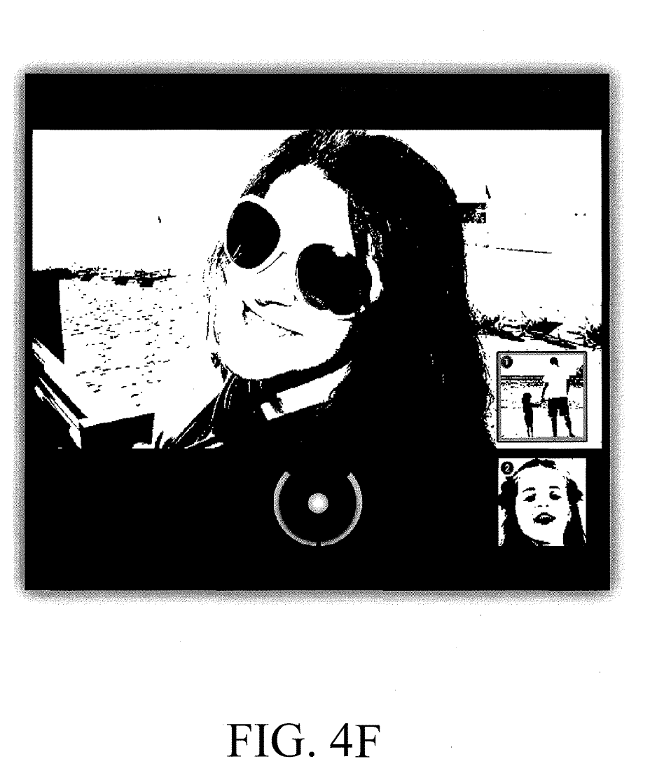

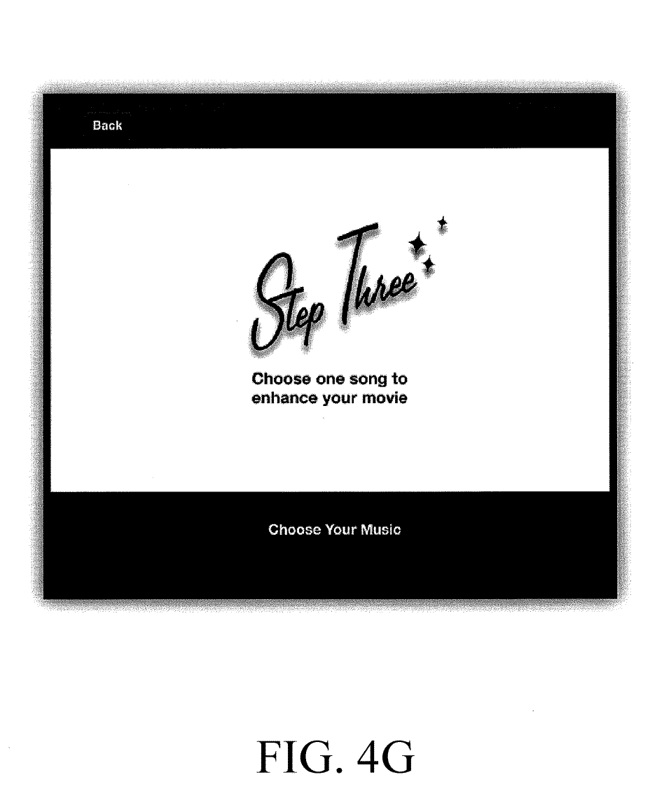

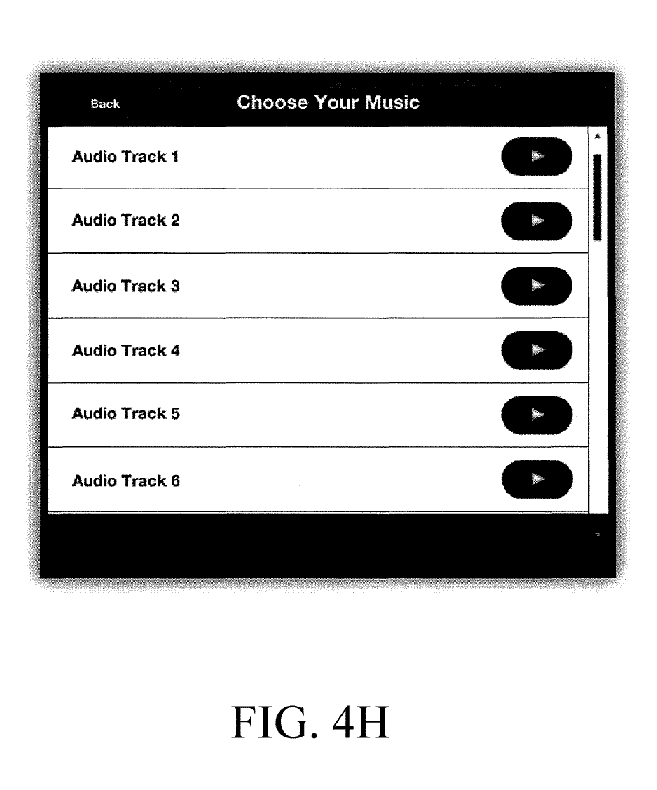

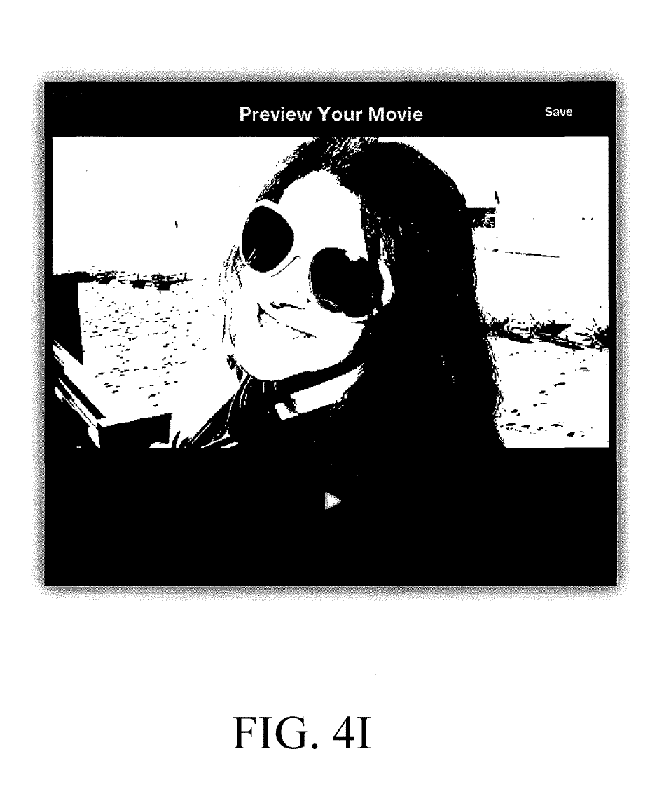

FIGS. 4A-4I depict the display of a hand-held device such as a cell-phone during execution of some of the steps of FIG. 2. FIGS. 4A-4B illustrate the user choosing previously created video segments and photos as in step 220. The device designates these previously created video segments and photos as “video clips.”

FIGS. 4C-4E illustrate the device instructing the user as in step 230 to create a master video. The master video may comprise a recording of the user describing the video clips, with the user featured on camera (or with audio only). FIGS. 4D and 4E depict the display of a hand-held device while recording a master video for a final presentation to be compiled from the master video and one video clip. The thumb-nail image of the video clip is shown in the bottom right quadrant of the display. FIG. 4F depicts the display of a hand-held device while recording a master video for a final presentation to be compiled from the master video and two video clips. The thumb-nail image of both video clips are shown in the bottom right quadrant of the display.

FIGS. 4G and 4H illustrate receiving audio clip selections from the user as in step 270 as well as text based name or description information on the collective video subject. FIG. 4I illustrates that the user can review the final presentation video. The user may also be provided the options to repeat previous steps, save the final video, or distribute the video including but not limited to distributing via Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this document.

A specific example of the invention is as follows.

User is employed in the Human Resources department of a large corporation. User is required to prepare a video presentation briefly describing an employment opportunity at the corporation and an overview of the corporation. User selects from device 100 a video presentation type that will compile a video presentation using one video clip stored on the device 100. The device displays video clips stored in memory of the device and the user selects a video clip for the presentation. User then records a master video comprising a video track showing the user speaking and an audio track comprising the user's brief verbal description of the employment opportunity and an overview of the corporation. While the device 100 is recording the master video, a thumb-nail image of the selected video clip is shown on the display 153. The type of presentation selected by the user is a 30-second presentation. Upon recording the master video for 30 seconds, without any input from the user, the device 100 terminates the recording, saves the recording to memory in device 100, and compiles a final presentation by replacing a middle portion of the master video with the video track of the video clip. The user is then given the option to save or distribute the final presentation.

Numerous variations may be made in the practice of the invention. Computing device 100 is only illustrative of computing systems and user interfaces that may be used in the practice of the invention. The processing unit(s) 110, memory 170, display 153 and camera(s) 156 may all be enclosed in one casing as in a smartphone or the like; or some or all of these components may be in separate units. If these components are separate, they may all be located near to one another as on a desk-top; or they may be considerable distances apart. For example, the memory, camera and display may be at one location while the processor that controls these components in the practice of the invention may be elsewhere connected by a communication link such as the Internet.

Numerous variations may be practiced in the steps described in FIG. 2. For example, some embodiments may not provide for selection of a music soundtrack for use in the finished video presentation.

While the invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the invention is capable of being embodied in other forms without departing from its essential characteristics.

1. A computing device comprising:
a display;
an audio input;
a video input;
a memory;
a first video clip stored in the memory, said first video clip having a video track and a first duration;
one or more processors coupled to the memory; and
computer software stored in the memory and executable by the one or more processors, said computer software comprising instructions for:
recording a master video comprising an audio track and a video track, wherein while the master video is recording, no user input is received by the computer device indicating a selection of the first video clip;
saving said master video to the memory;
upon saving the master video to the memory, compiling a video presentation by, between a first location and a second location of the master video, replacing the video track of the master video with the video track of the first video clip; and
saving the video presentation to the memory or another computer-readable medium.

2. The computing device of claim 1 wherein the computer software further comprises instructions for truncating the video clip to the duration of time between the first location and the second location of the master video.

3. The computing device of claim 1 wherein the audio track of the master video comprises recorded speech, and wherein the computer software further comprises one or more instructions for setting the first location of the master video by identifying a pre-determined reduction in the volume level of the speech.

4. The computing device of claim 3 wherein the computer software further comprises one or more instructions that preclude setting the first location of the master video prior to a predetermined location of the master video.

5. The computing device of claim 1 wherein at least one audio track comprising a music track is stored in the memory, and the computer software further comprises one or more instructions for:
receiving a command to add a music track to the master video; and
adding a music track to the master video.

6. The computing device of claim 5 wherein the computer software further comprises one or more instructions for detecting the portions of the audio track of the master video during which speech is recorded and decreasing the volume of the music at those portions.

7. The computing device of claim 1 wherein the computer software further comprises one or more instructions for displaying on the display, during recording of the master video, the difference in time between the duration of the first video clip and the time the master video has been recorded subsequent to the first location of the master video.

8. The computing device of claim 1 wherein the computer software further comprises one or more instructions for, during recording of the master video, providing an indication when the recording time of the master video equals the time from the start of the master video to the second location of the master video.

9. The computer device of claim 1 wherein the computer software further comprises one or more instructions for displaying the first video clip on the display starting at a time corresponding to the first location of the master video.

10. A computing device comprising:
a display;
an audio input;
a video input;
a memory;
a first video clip stored in the memory, said first video clip having a video track and a first duration;
a second video clip stored in the memory, said second video clip having a video track and a second duration;
one or more processors coupled to the memory; and
computer software stored in the memory and executable by the one or more processors, said computer software comprising instructions for:
recording a master video comprising an audio track and a video track, wherein while the master video is recording, no user input is received by the computer device indicating a selection of the first video clip or the second video clip;
saving said master video to the memory;
upon saving the master video to the memory, compiling the video presentation by, between a first location and a second location of the master video, replacing the video track of the master video with the first video clip, and between a third location and a fourth location of the master video, replacing the video track of the master video with the second video clip; and
saving the video presentation to the memory or another computer-readable medium.

11. The computing device of claim 10 wherein the computer software further comprises one or more instructions for truncating the first video clip to the duration of time between the first location and the second location of the master video.

12. The computing device of claim 11 wherein the computer software further comprises one or more instructions for truncating the second video clip to the duration of time between the third location and the fourth location of the master video.

13. The computing device of claim 10 wherein the audio track of the master video comprises recorded speech, and wherein the computer software further comprises one or more instructions for determining the first location of the master video by identifying a pre-determined reduction in the volume level of the speech.

14. The computing device of claim 13 wherein the computer software further comprises one or more instructions that preclude determination of a first location of the master video prior to a predetermined location of the master video.

15. The computing device of claim 10 wherein at least one audio track comprising a music track is stored in the memory, and the computer software further comprises one or more instructions for:
receiving a command to add a music track to the master video; and
adding a music track to the master video.

16. The computing device of claim 15 wherein the computer software further comprises one or more instructions for detecting the portions of the audio track of the master video during which speech is recorded and decreasing the volume of the music at those portions.

17. The computing device of claim 10 wherein the computer software further comprises one or more instructions for displaying on the display, during recording of the master video, the difference in time between the duration of the first video clip and the time the master video has been recorded subsequent to the first location of the master video.

18. The computing device of claim 10 wherein the computer software further comprises one or more instructions for, during recording of the master video, providing an indication when the recording time of the master video equals the time from the start of the master video to the second location of the master video.

19. The computing device of claim 10 wherein the computer software further comprises one or more instructions for displaying the first video clip on the display starting at a time corresponding to the first location of the master video.

20. The computing device of claim 11 wherein, during recording of the master video, displaying on the display user the second video clip starting at a time corresponding to the second location of the master video.
